(19) United States
(12) Patent Application Publication
(10) Pub. No.: US 2020/0232078 A1
(43) Pub. Date: Jul. 23, 2020

(54) STEEL SUITABLE FOR HOT WORKING TOOLS

(71) Applicant: Uddeholms AB, Hagfors (SE)

(72) Inventors: Sebastian Ejnermark, Hammarö (SE); Christos Oikonomou, Karlstad (SE); Olof Tönnberg, Ekshärad (SE); Venkata Seshendra Karamchedu, Göteborg (SE); Richard Oliver, Östra Ämtervik (SE)

(21) Appl. No.: 16/650,604

(22) PCT Filed: Oct. 5, 2018
(86) PCT No.: PCT/SE2018/051022

§ 371 Date: Mar. 25, 2020

(30) Foreign Application Priority Data
Oct. 9, 2017 (SE) 1751249-2

(51) Int. Cl. C22C 38/52; C22C 38/46; C22C 38/44; C22C 38/42; C22C 38/04; C22C 38/02; C22C 38/00; C21D 9/00; C22C 1/02; C22C 33/02; B22F 1/00; B33Y 70/00

(52) U.S. Cl. CPC C22C 38/52; C21D 2211/008; C22C 38/44; C22C 38/42; C22C 38/04; C22C 38/02; C22C 38/001; C21D 9/0068; C22C 1/02; C22C 33/0285; B22F 1/0014; B22F 1/0048; B33Y 70/00; C21D 2211/001; C22C 38/46

(57) ABSTRACT

The invention is directed to a steel for making a hot working tool, the steel consists of in weight % (wt. %):

| | |
|---|---|
| C | 0.01-0.08 |
| Si | 0.05-0.6 |
| Mn | 0.1-0.8 |
| Cr | 3.9-6.1 |
| Ni | 1.0-3.0 |
| Mo | 7.0-9.0 |
| Co | 9.0-12.5 |
| Cu | 0.2-6.5 |
| N | 0.01-0.15 |

Balance optional elements, impurities and Fe.

The invention is also directed to pre-alloyed powders made from said alloy and AM articles produced from said powder.

### TECHNICAL FIELD

The invention relates to a steel suitable for hot working tools such as dies and moulds. In particular, the invention relates to precipitation hardening steel suitable for the manufacturing of hot work tools requiring a high hardness and a high tempering resistance.

### BACKGROUND OF THE INVENTION

For hot working application, it has been common to use different kinds of hot working tool steels, in particular 5% Cr steels like H11 and H13. is a premium hot work tool of this type. Uddeholm DIEVAR® is a premium hot work tool of this type. It is a high performance chromium-molybdenum-vanadium steel produced by ESR. It contains balanced carbon and vanadium contents as described in WO9950468 A1.

Although the vanadium alloyed tool steels produced by ESR have better properties than conventionally produced tool steels with respect to many properties, there is a need for further improvements in order to reduce the risk for hot work tool failures. In addition, it would be beneficial to further improve the hot strength and temper resistance of hot work tool steel in order to prolong the service life

It is also known to use maraging steels for hot work applications. Maraging steels are often stainless and embrace 17-7PH, 17-4 PH, 15-5 PH, PH 15-7Mo, PH 14-8Mo and PH 13-8Mo. The latter steel is also designated 1.4534, X3CrNiMoAl13-8-2 and 513800.

### DISCLOSURE OF THE INVENTION

This invention is directed to an improved hot work tool steel. In particular, the invention is directed to a hot work tool steel having a high hardness and a high temper resistance.

The object of the present invention is to provide a steel having an improved property profile for hot working. In particular the present invention aims at providing a precipitation hardening mould steel having a high strength and toughness as well as a high cleanliness, a good polishability and uniform properties also in large dimensions. In addition, the invention aims at providing the steel in form of a powder, in particular, but not restricted, to a steel powder suitable for Additive Manufacturing (AM).

A further object is to provide articles formed by an additive manufacturing method by using the inventive powder.

The foregoing objects, as well as additional advantages are achieved to a significant measure by providing a steel as defined in the alloy claims.

The invention is defined in the claims.

The general object is solved by providing a steel consisting of, in weight % (wt. %):

| | |
|---|---|
| C | 0.01-0.08 |
| Si | 0.05-0.6 |
| Mn | 0.1-0.8 |
| Cr | 3.9-6.1 |
| Ni | 1.0-3.0 |
| Mo | 7.0-9.0 |
| Co | 9.0-12.5 |
| Cu | 0.2-6.5 |

optionally

| | |
|---|---|
| N | 0.01-0.15 |
| B | <0.008 |
| S | <0.25 |
| V | <2 |
| Nb | <1 |
| Ti | <2 |
| Zr | <2 |
| Ta | <2 |
| Hf | <2 |
| Y | <2 |
| Ca | <0.009 |
| Mg | <0.01 |
| REM | <0.2 |

Fe and impurities balance.

### DETAILED DESCRIPTION

The importance of the separate elements and their interaction with each other as well as the limitations of the chemical ingredients of the claimed alloy are briefly explained in the following. All percentages for the chemical composition of the steel are given in weight % (wt. %) throughout the description. The amount of phases is given in volume % (vol. %). Upper and lower limits of the individual elements can be freely combined within the limits set out in the claims. The arithmetic precision of the numerical values of can be increased by one digit. Hence, a value of given as e.g. 0.1% can also be expressed as 0.10%.

Carbon (0.01-0.08%)

Carbon is effective for improving the strength and the hardness of the steel. However, if the content is too high, the steel may be difficult to machine after cooling from hot working. C should be present in a minimum content of 0.01%, preferably at least 0.02%. The upper limit for carbon is 0.08%. The upper limit may be 0.07, 0.06, 0.055 or 0.05%. The nominal content is about 0.030%. A low carbon content improves the formability and gives a good combination of strength and thoughness

Silicon (0.05-0.6%)

Silicon is used for deoxidation. Si is also a strong ferrite former. Si is therefore limited to 0.6%. The upper limit may be 0.55, 0.50, 0.40, 0.35, 0.34, 0.33, 0.32, 0.31, 0.30, 0.29 or 0.28%. The lower limit may be 0.10, 0.12, 0.14, 0.16, 0.18 or 0.20%. Preferred ranges are 0.15-0.40% and 0.20-0.35%.

Manganese (0.1-0.8%)

Manganese contributes to improving the hardenability of the steel. If the content is too low then the hardenability may be too low. At higher sulphur contents manganese prevents red brittleness in the steel. Manganese shall therefore be present in a minimum content of 0.10%, preferably at least 0.15, 0.20, 0.25 or 0.30%. The steel shall contain maximum 0.8% Mn, preferably maximum 0.75, 0.70, 0.65, 0.60, 0.50, 0.45, 0.40 or 0.35%. A preferred range is 020-0.40%.

Chromium (3.9-6.1%)

Chromium is to be present in a content of at least 3.9% in order to provide a good hardenability and corrosion resistance. The lower limit may be 4.0, 4.1, 4.2, 4.3, 4.4 or 4.5%. If the chromium content is too high, this may lead to the formation of undesired phases. The upper limit is therefore 6.1% and may be set to 6.0, 59, 5.8, 5.7, 5.6 or 5.5%.

Nickel (1-3%)

Nickel is an austenite stabilizer, which supresses the formation of delta ferrite. Nickel gives the steel a good hardenability and toughness. Nickel is also beneficial for the machinability and polishability of the steel. However, excess Ni additions results in too high an amount of retained austenite. The lower limit may be set to 1.1, 1.2, 1.3, 1.4 or 1.5%. The upper limit may be set to 2.9, 2.8, 2.7, 2.6 or 2.5%.

Molybdenum (7.0-9.0%)

Mo in solid solution is known to have a very favourable effect on the hardenability. Molybdenum is a strong carbide forming element and also a strong ferrite former. Mo is in the present invention required for the formation of the precipitation hardening during aging. For this reason the amount of Mo should be 7-9%. The lower limit may be 7.1, 7.2, 7.3 or 7.4%. The upper limit may be 8.9, 8.8, 8.7, 8.6, or 8.5%.

Cobalt (9.0-12.5%)

Cobalt is dissolved in the matrix in maraging steels and does not participate in precipitation. However, Cobalt generally raises the Mₛ temperature and therefore increases the permissible amount of other age-hardening elements without leaving too much retained austenite. Cobalt lowers the solid solubility of molybdenum in martensite and promotes a stronger precipitation of molybdenum contacting particles leading to a increased hardness. However, very high Co contents may reduce the Mₛ temperature in maraging steels with high contents of Mo. Co is therefore limited to 12.5% and the upper limit may be 12.4, 12.3, 12.2, 12.1, 12.0, 11.9, 11.8 or 11.7%. The lower limit may be 9.5, 9.7, 9.9, 10.1, 10.2, 10.3, 10.4 or 10.5%.

Nitrogen (0.01-0.15%)

Nitrogen is a strong austenite former and also a strong nitride former. Nitrogen is present in the range of 0.01-0.15%, preferably 0.02-0.07%. The lower limit may be 0.01, 0.02 or 0.03%. The upper limit may therefore be 0.10, 0.09, 0.08, 0.07, or 0.06%.

The inventors of the present invention have surprisingly found, that nitrogen can be deliberately added to the steel without impairing the polishability.

Copper (0.2-6.5%)

Cu is an element, which contribute to increase the hardness and the corrosion resistance of the steel. The ε-Cu phase formed during aging not only reinforces the steel by precipitation hardening, but also affects the precipitation kinetics of the intermetallic phases. In addition thereto, it would appear that additions of Cu result in a slower growth of the intermetallic phases at higher working temperatures. The upper limit for Cu may be 6.0, 5.5, 4.5, 4.0, 3.5, 3.0, 2.5 or 2.0%. The lower limit for Cu may 0.2, 0.3, 0.4, 0.5, 0.6, 0.7, 0.8 or 0.9%.

Boron (0.002-0.0008%)

Boron is an optional element that can be used in small amounts in order to increase the hardenability and to improve the hot workability of the stainless steel. The upper limit may then be set to 0.007, 0.006, 0.005 or 0.004%.

Sulphur (0.01-0.25%)

S may optionally be added in order to improve the machinability of the steel. If S is used for this purpose, then S is deliberately added to the steel in an amount of 0.01-0.25%. At higher sulphur contents there is a risk for red brittleness. Moreover, high sulphur contents may have a negative effect on the fatigue properties and on the polishability of the steel. The upper limit shall therefore be 0.25%, preferably 0.1% most preferably 0.03%. A preferred range is 0.015-0.030%. However, if not deliberately added, then the amount of S is restricted to impurity contents as set out below.

Niobium (≤1%)

Nb is a strong carbide and nitride former. The content of this elements should therefore be limited in order to avoid the formation of undesired carbides and nitrides. The maximum amount of Nb is therefore 1%. Nb is normally not deliberately added. The allowable impurity content can be set to 0.05, 0.03, 0.01 or 0.005%.

Ti, Zr, Ta, Hf and Y (≤2%)

These elements may form compounds with C, B, N and/or O. They can be used to produce an Oxide Dispersion Strengthened (ODS) or a Nitride Dispersion Strengthened (NDS) alloy. The upper limit is then 2% for each of these elements. The upper limit may be 1.5, 1.0, 0.5 or 0.3%. However, if these elements are not deliberately added for making an ODS alloy, then the upper limit may be 0.1, 0.05, 0.01 or 0.005%.

Ca, Mg, O and REM (Rare Earth Metals)

These elements may optionally be added to the steel in the claimed amounts for different reasons. These elements are commonly used to modify the non-metallic inclusion and/or in order to further improve the machinability, hot workability and/or weldability of the steel. The oxygen content is then preferably limited to 0.03%. However, if Oxygen is used in order to form an Oxide Dispersion Strengthened (ODS) alloy, then the upper limit may be as high as 0.80%. The oxide can be admixed to a powder of be formed in-situ, e.g. by gas atomizing, in particular by using Gas Atomizing Reaction Synthesis (GARS) or during an Additive Manufacturing (AM) method, in particular through atmospheric reaction in Liquid Metal Deposition (LMD).

Impurity Elements

P, S and O are the main impurities, which may have a negative effect on the mechanical properties of the steel. P may therefore be limited to 0.05, 0.04, 0.03 0.02 or 0.01%.

If sulphur is not deliberately added, then the impurity content of S may be limited to 0.05, 0.04, 0.003, 0.001, 0.0008, 0.0005 or even 0.0001%.

In one embodiment the steel fulfils at least one of the following requirements:

| | |
|---|---|
| C | 0.01-0.06 |
| Si | 0.1-0.5 |
| Mn | 0.1-0.6 |
| Cr | 4.0-6.0 |
| Ni | 1.2-2.9 |
| Mo | 7.1-8.9 |
| Co | 9.5-12.0 |
| Cu | 0.3-5.0 |
| N | 0.02-0.08 |

In a further embodiment the steel fulfils at least one of the following requirements:

| | |
|---|---|
| C | 0.02-0.04 |
| Si | 0.2-0.4 |
| Mn | 0.2-0.6 |
| Cr | 4.5-5.5 |
| Ni | 1.5-2.5 |
| Cr + Ni | 6.0-8.0 |
| Mo | 7.5-8.5 |
| Co | 10.5-11.7 |
| Cu | 0.4-4.0 |
| N | 0.02-0.06 |

and/or wherein the the matrix comprises ≥80 vol. % martensite and/or 20 vol. % austenite and/or the matrix hardness is 45-58 HRC.
and/or wherein the steel has a thickness of at least 100 mm and the maximum deviation from the mean Brinell hardness value HBW_{10/3000} in the thickness direction measured in accordance with ASTM E10-01 is less than 5%, and wherein the minimum distance of the centre of the indentation from the edge of the specimen or edge of another indentation shall be at least two and a half times the diameter of the indentation and the maximum distance shall be no more than 4 times the diameter of the indentation and/or the steel has a cleanliness fulfilling the following maximum requirements with respect to micro-slag according to ASTM E45-97, Method A:

| A | A | B | B | C | C | D | D |
|---|---|---|---|---|---|---|---|
| T | H | T | H | T | H | T | H |
| 1.0 | 0 | 1.5 | 1.0 | 0 | 0 | 1.5 | 1.0 |

In a preferred embodiment the steel fulfils the following requirements:

| | |
|---|---|
| C | 0.025-0.055 |
| Si | 0.15-0.40 |
| Mn | 0.15-0.50 |
| Cr | 4.5-5.5 |
| Ni | 1.5-2.5 |
| Mo | 7.5-8.5 |
| Co | 10.5-11.7 |
| Cu | 0.4-4.0 |
| N | 0.02-0.06 |

The alloys of the present invention can be produced by any suitable method. Non-limiting examples of suitable methods include:
a) Conventional melt metallurgy followed by casting and hot working.
b) Powder Metallurgy (PM).
c) Rapid solidification with more than 10³° C./s.

PM powders can be produced by conventional gas- or water-atomization of pre-alloyed steel.

If the powder shall be used for AM, then gas-atomization is the preferred atomization method, because it is important to use a technique, that produces powder particles having a high degree of roundness and a low amount of satellites. In particular, the close-coupled gas atomization method can be used for this purpose.

It is preferred that at least 80% of the gas-atomized powder particles have a size in the range of 5 to 150 μm. The maximum size of the powder particles for AM is 150 μm, and the preferred size range is 10-100 μm with a mean size of about 25-45 μm.

The AM methods of prime interest are Liquid Metal Deposition (LMD), Selective Laser Melting (SLM) and Electron Beam Melting (EBM). The powder characteristics are also of importance for AM. The powder size distribution measured with a Camsizer according to ISO 4497 should fulfil the following requirements (in μm):
5≤D10≤35
20≤D50≤55
   D90≤80

Preferably, at least 90% of the powder particles have a size in the range of 10 to 100 μm preferably the powder should fulfil at least one of the following size requirements (in μm):
10≤D10≤30
25≤D50≤45
   D90≤70

Even more preferred is that the coarse size fraction D90 is limited to 60 μm or even 55 μm.

The sphericity of the powder should be high. The sphericity (SPHT) can be measured by a Camsizer and is definined in ISO 9276-6. SPHT=4 πA/P², where A is the measured area covered by a particle projection and P is the measured perimeter/circumference of a particle projection. The mean SPHT should be at least 0.80 and can preferably be at least 0.85, 0.90, 0.91, 0.92 0.93, 0.94 or even 0.95. In addition, not more than 5% of the particles should have a SPHT 0.70. In addition to SPHT, the aspect ratio can be used in the classifying of the powder particles. The aspect ratio is defined as b/I, wherein b is the shortest width of the particle projection and I is the longest diameter. The mean aspect ratio should preferably be at least 0.85 or more preferably 0.86, 0.87, 0.88, 0.89, or 0.90.

The inventive alloy is a precipitation hardenable steel having a martensitic matrix.

Articles can be formed from the inventive pre-alloyed powder by any suitable PM-method such as PIM, MIM, ROC, HIP and conventional press and sinter. Preferably, an additive manufacturing (AM) method is used. The AM-articles should fulfil at least one of the following requirements:
the matrix comprises 80 vol. % martensite,
the matrix comprises 20 vol. % austenite,
the matrix hardness is 34-56 HRC,
the Charpy V-notch value perpendicular to the build direction is ≥5 J,
the tensile strength Rₘ perpendicular to the build direction is ≥1600 MPa,
the yield strength Rc_{0.2} perpendicular to the build direction is ≥1500 MPa, the compressive yield strength Rc_{0.2} perpendicular to the build direction is at least 10% higher than tensile yield strength Rp_{0.2}.

The Charpy impact test can be performed according to EN 10045-1, ISO 148 and/or ASTM A370 using standard specimen size of 10 mm×10 mm×55 mm. The austenite content can be measured using X-ray diffraction (XRD) and/or Electron Backscattered Diffraction (EBSD) in the SEM.

### Example

In this example two inventive alloys are compared to the premium hot work steel Uddeholm Dievar®

The alloys had the following nominal compositions (in wt. %):

| | | | Uddeholm |
|---|---|---|---|
| | Steel 1 | Steel 2 | Dievar ® |
| C | 0.03 | 0.03 | 0.36 |
| Si | 0.3 | 0.3 | 0.20 |
| Mn | 0.3 | 0.3 | 0.5 |
| Cr | 5 | 5 | 5 |
| Ni | 2 | 2 | — |
| Mo | 8 | 8 | 2.3 |
| V | — | — | 0.55 |
| Co | 11 | 11 | — |
| Cu | 0.5 | 2.0 | — |
| N | 0.03 | 0.03 | 0.007 |

balance iron and impurities.

The inventive steels were formed by melting and casting into small ingots of a weight of about 100 g. After cooling to room temperature, these steels were subjected to tempering twice for two hours (2×2 h) at 620° C.

The comparative steel was conventionally produced and subjected to austenitization at 1020° C. in a vacuum furnace followed by gas quenching with a time of 100 s in the interval 800-500° C. (t_{8/5}=100 s). After cooling to room temperature also the comparative steel was subjected to tempering twice for two hours (2×2h) at 615° C.

The tempering resistance of the alloys was thereafter examined at a temperature of 600° C. The results are given in Table 1.

TABLE 1
Tempering resistance at 600°
C. Hardness (HRC) as a function of time.

| | | | Uddeholm |
|---|---|---|---|
| Time (h) | Steel 1 | Steel 2 | Dievar ® |
| 0 | 53.7 | 53.9 | 45.1 |
| 27 | 52.0 | 52.0 | 36.4 |
| 50 | 50.5 | 51.1 | 34.4 |
| 100 | 48.7 | 49.3 | 31.2 |

Although both inventive steels had a higher initial hardness at the beginning of the test it is apparent from Table 1 that the inventive steels had a significant better tempering resistance than the comparative steel Uddeholm Dievar®. The decrease in hardness after exposure to 600° C. for 100 hours was about 5 HRC for the inventive steels whereas it was about 14 HRC for the comparative steel. Accordingly, it may be concluded that the inventive steel has not only a remarkably high initial hardness but also a superior tempering resistance.

### INDUSTRIAL APPLICABILITY

The steel of the present invention is particularly useful in dies requiring a high and uniform hardness as well as high tempering resistance. The steel of the present invention is also very suitable as a powder for PM and for the production of articles by AM.

1. A steel for making a hot working tool, the steel consists of in weight % (wt. %):

| | |
|---|---|
| C | 0.01-0.08 |
| Si | 0.05-0.6 |
| Mn | 0.1-0.8 |
| Cr | 3.9-6.1 |
| Ni | 1.0-3.0 |
| Mo | 7.0-9.0 |
| Co | 9.0-12.5 |
| Cu | 0.2-6.5 |
| N | 0.01-0.15 |

optionally

| | |
|---|---|
| B | <0.008 |
| S | <0.25 |
| V | <2 |
| Nb | <1 |
| Ti | <2 |
| Zr | <2 |
| Ta | <2 |
| Hf | <2 |
| Y | <2 |
| Ca | <0.009 |
| Mg | <0.01 |
| REM | <0.2 |

Fe and impurities balance.

2. A steel according to claim 1, which fulfils at least one of the following requirements:

| | |
|---|---|
| C | 0.01-0.06 |
| Si | 0.1-0.5 |
| Mn | 0.1-0.6 |
| Cr | 4.0-6.0 |
| Ni | 1.2-2.9 |
| Mo | 7.1-8.9 |
| Co | 9.5-12.0 |
| Cu | 0.3-5.0 |
| N | 0.02-0.08 |

3. A steel according to claim 1, which fulfils at least one of the following requirements:

| | |
|---|---|
| C | 0.02-0.04 |
| Si | 0.2-0.4 |
| Mn | 0.2-0.6 |
| Cr | 4.5-5.5 |
| Ni | 1.5-2.5 |
| Cr + Ni | 6.0-8.0 |
| Mo | 7.5-8.5 |
| Co | 10.5-11.7 |
| Cu | 0.4-4.0 |
| N | 0.02-0.06 |

the matrix comprises ≥80 vol. % martensite,
the matrix comprises ≤20 vol. % austenite,
the matrix hardness is 45-58 HRC,
and/or wherein the steel has a thickness of at least 100 mm and the maximum deviation from the mean Brinell hardness value HBW_{10/3000} in the thickness direction measured in accordance with ASTM E10-01 is less than 5%, and wherein the minimum distance of the centre of the indentation from the edge of the specimen or edge of another indentation shall be at least two and a half times the diameter of the indentation and the maximum distance shall be no more than 4 times the diameter of the indentation, and/or
the steel has a cleanliness fulfilling the following maximum requirements with respect to micro-slag according to ASTM E45-97, Method A:

| A | A | B | B | C | C | D | D |
|---|---|---|---|---|---|---|---|
| T | H | T | H | T | H | T | H |
| 1.0 | 0 | 1.5 | 1.0 | 0 | 0 | 1.5 | 1.0 |

4. A steel according to claim 1, which fulfils the following requirements:

| | |
|---|---|
| C | 0.025-0.055 |
| Si | 0.15-0.40 |
| Mn | 0.15-0.50 |
| Cr | 4.5-5.5 |
| Ni | 1.5-2.5 |
| Mo | 7.5-8.5 |
| Co | 10.5-11.7 |
| Cu | 0.4-4.0 |
| N | 0.02-0.06 |

5. A pre-alloyed powder having a composition as defined in claim 1.

6. A pre-alloyed powder as defined in claim 5, wherein the powder is produced by gas atomizing, at least 80% of the powder particles have a size in the range of 5 to 150 μm the and wherein the powder fulfils at least one of the following requirements:

| | | | |
|---|---|---|---|
| Powder size distribution (in μm): | 5≤ | D10 | ≤35 |
| | 20≤ | D50 | ≤55 |
| | | D90 | ≤80 |
| Mean sphericity, SPHT | ≥0.85 | | |
| Mean aspect ratio, b/l | ≥0.85 | | |

wherein SPHT=4πA/P², where A is the measured area covered by a particle projection and P is the measured perimeter/circumference of a particle projection and the sphericity (SPHT) is measured by a Camsizer in accordance with ISO 9276-6, and wherein b is the shortest width of the particle projection and I is the longest diameter.

7. A pre-alloyed powder as defined in claim 6, wherein at least 90% of the powder particles have a size in the range of 10 to 100 μm the and wherein the powder fulfils at least one of the following requirements:

| | | | |
|---|---|---|---|
| Powder size distribution (in μm): | 10≤ | D10 | ≤30 |
| | 25≤ | D50 | ≤45 |
| | | D90 | ≤70 |
| Mean sphericity, SPHT | ≥0.90 | | |
| Mean aspect ratio, b/l | ≥0.88 | | |

8. An article formed by an additive manufacturing method using a pre-alloyed powder as defined in claim 5, wherein the article fulfils at least one of the following requirements:
the matrix comprises ≥80 vol. % martensite,
the matrix comprises ≤20 vol. % austenite,
the matrix hardness is 34-56 HRC,
the Charpy V-notch value perpendicular to the build direction is ≥5 J,
the tensile strength Rₘ perpendicular to the build direction is ≥1600 MPa,
the yield strength Rc_{0.2} perpendicular to the build direction is ≥1500 MPa,
the compressive yield strength Rc_{0.2} perpendicular to the build direction is at least 10 higher than tensile yield strength Rp_{0.2}.

9. An article according to claim 8, wherein the article after aging two times at 620° C. for two hours has a hardness at room temperature of at least 52 HRC and wherein said hardness is at least 50 HRC after the article has been exposed to a temperature of 600° C. for 50 hours.
